(19) United States
(12) Patent Application Publication
(10) Pub. No.: US 2005/0286864 A1
(43) Pub. Date: Dec. 29, 2005

(54) Recording and reproducing apparatus and dubbing method

(75) Inventor: Kouji Saito, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/144,783

(22) Filed: Jun. 6, 2005

(30) Foreign Application Priority Data
Jun. 29, 2004 (JP) 2004-192273

(51) Int. Cl. H04N 5/76; H04N 5/781; G11B 27/00

(52) U.S. Cl. 386/52; 386/125

(57) ABSTRACT

Disclosed is a recording and reproducing apparatus which includes: a type information requesting unit configured to request other recording and reproducing apparatuses connected via a network to transmit type information of storage devices mounted in the other recording and reproducing apparatuses via the network; a type information receiving unit configured to receive the type information of the storage devices which is transmitted in response to the request; and an addressing unit configured to assign, if the received type information of the storage devices is information indicating a storage device of unregistered type, address information secured for an unregistered type in advance to the storage device.

### CROSS-REFERENCE TO RELATED APPLICATION

This application is based upon and claims the benefit of priority from the prior Japanese Patent Application No. 2004-192273, filed on Jun. 29, 2004; the entire contents of which are incorporated herein by reference.

### BACKGROUND

1. Field of the Invention

The present invention relates to a recording and reproducing apparatus capable of dubbing or the like of contents in digital format for example and a dubbing method for such an apparatus.

2. Description of the Related Art

In recent years, apparatuses capable of recording and reproducing contents such as video software in digital format are rapidly gaining popularity. Among them, apparatuses which can correspond to recording/reproducing of plural types of recording media and have a dubbing (copying) function between these media are more accepted in the market.

For example, there is proposed a recording and reproducing apparatus adopting an optical disc and a hard disk which can correspond to writing of information such as DVD-RAM, DVD-R/RW, and the like as the above-described recording media (for example, refer to patent document 1)

Here, optical disks of the type exemplified above are reduced in cost nowadays, and they are readily available for general users. However, such optical disks are far behind current hard disks in terms of storage capacity and have problems when dubbing a large amount of contents.

[Patent Document 1] Japanese Patent Laid-open Application No. 2004-55010

Here, when dubbing a large amount of contents, it is useful to connect plural recording and reproducing apparatuses each having a hard disk for example to a network and to carry out dubbing or the like between the recording and reproducing apparatuses via the network. Nowadays, development of new storage devices for further improvement of storage capacity is in progress. Accordingly, as a demand for the above-described recording and reproducing apparatus in expectation of appearance of a next generation storage device, support of network dubbing in which this new storage device is designated as a dubbing destination via a network is conceivable.

### SUMMARY

An object of the present invention is to provide a recording and reproducing apparatus and a dubbing method capable of supporting a process of network dubbing to, for example, a next generation storage device which is expected to be adopted as a dubbing destination of contents.

A recording and reproducing apparatus according to an aspect of the present invention has: a type information requesting unit configured to request other recording and reproducing apparatuses connected via a network to transmit type information of storage devices mounted in the other recording and reproducing apparatuses via the network; a type information receiving unit configured to receive the type information of the storage devices which is transmitted in response to the request; and an addressing unit configured to assign, if the received type information of the storage devices is information indicating a storage device of unregistered type, address information secured for an unregistered type in advance to the storage device.

Specifically, according to the present invention, address information secured in advance can be assigned to even a storage device of unregistered type on the network, so that even an unknown (next generation) storage device to be adopted in the future can be specified as a dubbing destination of contents.

Further, a dubbing method according to an aspect of the present invention includes: requesting other recording and reproducing apparatuses connected via a network to transmit type information of storage devices mounted in the other recording and reproducing apparatuses via the network; receiving the type information of the storage devices which are transmitted in response to the request; and assigning, if the received type information of the storage devices is information indicating a storage device of unregistered type, address information secured for an unregistered type in advance to the storage device.

According to the present invention, a recording and reproducing apparatus and a dubbing method capable of supporting a process of network dubbing to, for example, a next generation storage device which is expected to be adopted as a dubbing destination of contents can be provided.

### BRIEF DESCRIPTION OF THE DRAWINGS

FIG. 1 is a block diagram showing a state that a recording and reproducing apparatus according to an embodiment of the present invention is connected to other recording and reproducing apparatuses via a network.

FIG. 2 is a functional block diagram showing the internal configuration of the recording and reproducing apparatus shown in FIG. 1.

FIG. 3 is an example of a list display screen displayed on a monitor connected to the recording and reproducing apparatus shown in FIG. 2 and showing storage devices which can be a dubbing destination and recording and reproducing apparatuses having the storage devices.

FIG. 4 is an example of a display screen showing dubbing statuses between the devices displayed on the monitor of FIG. 3.

FIG. 5 is a flowchart showing a process at the time of network dubbing in the recording and reproducing apparatus shown in FIG. 2.

FIG. 6 is a flowchart showing a first process (acceptance of a request for type information of a storage device and a reply process thereto) of a recording and reproducing apparatus to be a dubbing destination out of the recording and reproducing apparatuses in FIG. 1.

FIG. 7 is a flowchart showing a second process (acceptance of a dubbing possibility information request and a reply process thereto) of the recording and reproducing apparatus to be a dubbing destination out of the recording and reproducing apparatuses in FIG. 1.

FIG. 8 is a flowchart showing a third process (acceptance of a network dubbing start request and a post process thereof) of the recording and reproducing apparatus to be a dubbing destination out of the recording and reproducing apparatuses in FIG. 1.

### DETAILED DESCRIPTION

### (Explanation of Embodiments)

Embodiments of the present invention will be described with reference to the drawings, but these drawings are presented for illustrative purpose only and in no ways limit the present invention.

As a form of an aspect of the present invention, a dubbing possibility information requesting unit configured to request one of all storage devices on the network including the storage device to which the address information is newly assigned to transmit information indicating possibility of dubbing may be further included.

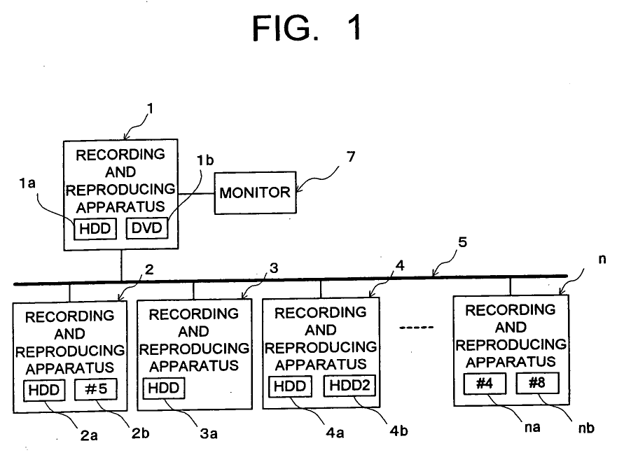

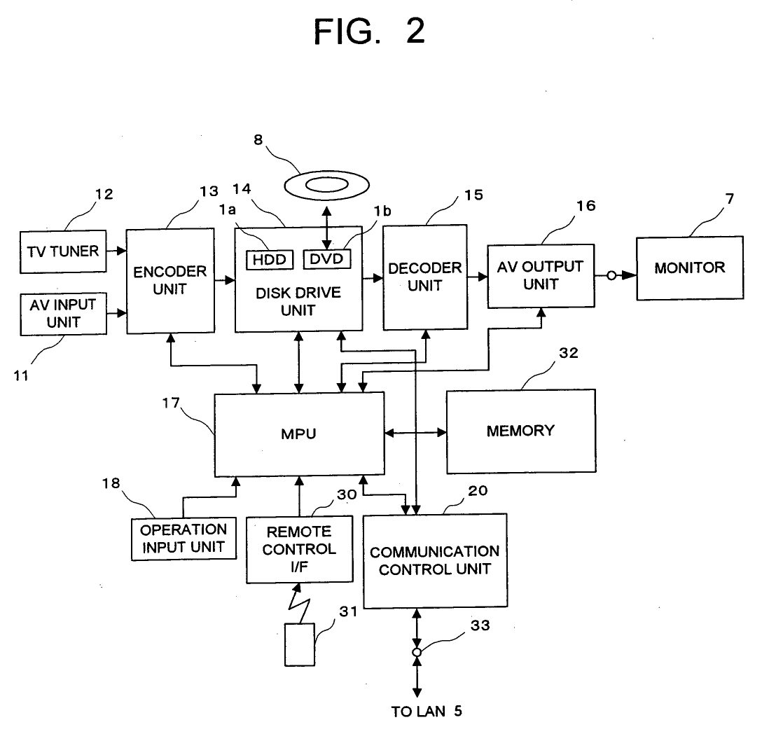

With respect to the above description, a best mode for carrying out the present invention will be explained based on the drawings. FIG. 1 is a block diagram showing a state that a recording and reproducing apparatus according to an embodiment of the present invention is connected to other recording and reproducing apparatuses via a network, and FIG. 2 is a functional block diagram showing the internal configuration of a recording and reproducing apparatus shown in FIG. 1.

As shown in FIG. 1 and FIG. 2, the recording and reproducing apparatus 1 of this embodiment is connected to other recording and reproducing apparatuses 2, 3, 4, . . . , n via a LAN (Local Area Network) 5 in order to realize network dubbing of contents to storage devices (recording media) of the other recording and reproducing apparatuses 2, 3, 4, . . . , n.

As shown in FIG. 2, the recording and reproducing apparatus 1 as a main part for carrying out dubbing is constituted of an AV (audiovisual) input unit 11, a TV (television) tuner 12, an encoder unit 13, a disk drive unit 14, a decoder unit 15, an AV output unit 16 configured to output display information to a monitor 7, an MPU (micro processing unit) 17, a memory 32, an operation input unit 18, a remote controller 31 configured to input a control signal via a remote control interface 30, and a communication control unit 20 configured to control communication via a LAN port 33. The disk drive unit 14 is provided with a DVD drive 1b configured to read/record information from/to an optical disk 8 such as DVD-RAM, DVD-R/RW, or the like, and an HD drive having a hard disk 1a.

The AV input unit 11 is an interface which inputs a video information signal and an audio information signal from the outside. Respective inputted signals are sent to the encoder unit 13. Respective signals inputted to the AV input unit 11 are conceivable to be either an analog format or a digital format. When the signal is in analog format, it is converted into a digital format in this AV input unit 11 or in a first stage of the encoder 13 of a next stage. The TV tuner 12 synchronizes with a broadcast wave and obtains a video information signal and an audio information signal. The obtained video information signal and sound information signal are sent to the encoder unit 13. The output of the TV tuner 12 is conceivable to be either an analog format or a digital format. When it is in analog format, it is converted into a digital format in the first stage of the encoder 13 of the next stage.

The encoder unit 13 performs encoding (including compression of information) of the sent video information signal and audio information signal into digital format signals for recording on a recording medium on the next stage. The encoded signal is sent to the disk drive unit 14. The disk drive unit 14 records signals on a recording medium, the optical disk 8 or the hard disk 1a, and reads and outputs signals recorded on these recording media. Further, the disk drive unit 14 is provided with a temporary storage unit (not shown) and performs buffering of signals by this temporary storage unit at the time of recording to or reading from these media.

The decoder unit 15 performs decoding (including expansion of information) of a signal read out by the disk drive unit 14. The decoded signal is sent to the AV output unit 16. The AV output unit 16 outputs the signal sent from the decoder unit 15 as a reproduction video signal and a reproduction audio signal to the outside. These output signals are conceivable to be either an analog format or a digital format. When outputting as an analog format, it is converted into an analog format in a last stage of the decoder 15 or in the AV output unit 16.

The MPU 17 comprehensively controls operation of this recording and reproducing apparatus 1, and is connected to the memory 32 via a system bus. The memory 32 includes a ROM storing an operation program of the recording and reproducing apparatus 1, a RAM providing a working area of this operation program, and so on. The MPU 17 controls the encoder unit 13, the disk drive unit 14, the decoder unit 15, and so on, and also requests, based on an input signal from the operation input unit 18, the other recording and reproducing apparatuses 2, 3, 4, . . . , n connected via a network, the LAN 5, to transmit type information of their retaining storage devices (recording media) for example via the communication control unit 20 and the LAN 5 (as a type information requesting unit).

The operation input unit 18 is a general input unit for a user to operate this recording and reproducing apparatus 1 and is used particularly for accepting selection of a dubbing destination storage device. The accepted selection is forwarded as a signal to the MPU 17. The monitor 7 also functions as a display part to display various information (information different from original video information and audio information) for the user.

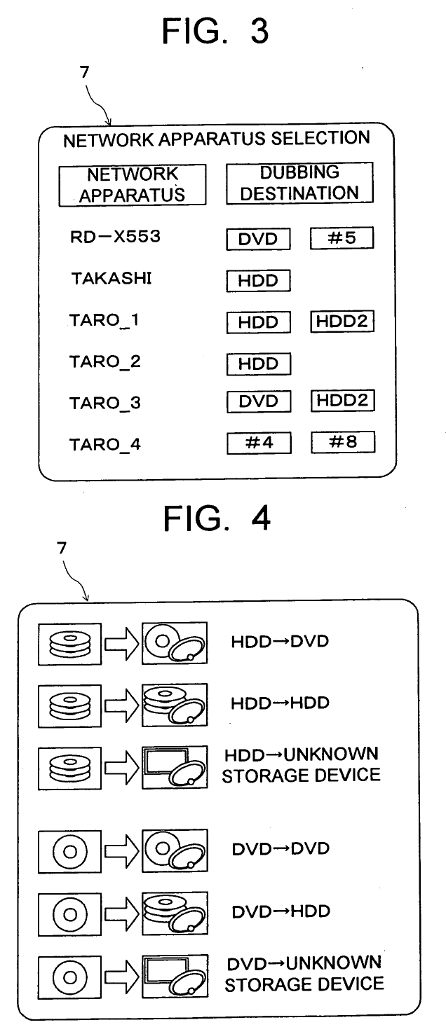

For example, when the MPU 17 functions as the type information requesting unit and requests transmission of type information of a storage device to the other recording and reproducing apparatuses 2, 3, 4, . . . , n as a broadcast message, the following information is displayed on the monitor 7 thereafter. First, network apparatus names (dubbing destination apparatus name) of the other recording and reproducing apparatuses 2, 3, 4, . . . , n are displayed, and storage device names (dubbing destination recording media name) of storage devices mounted in the other recording and reproducing apparatuses 2, 3, 4, . . . , n (refer to FIG. 3) are also displayed. This results from that the MPU 17 functions as a type information receiving unit to receive returned information from the other recording and reproducing apparatuses 2, 3, 4, . . . , n via the communication control unit 20 and further displays it on the monitor 7 via the AV output unit 16.

When the user is prompted by this display screen to select a storage device and selects a storage device to be a dubbing destination via the remote controller 31 or the operation input unit 18, dubbing of contents from the recording and reproducing apparatus 1 to that storage device via the LAN 5 is started. Here, the MPU 17 also functions as a selection requesting unit in terms of having the display screen to prompt user selection displayed on the monitor 7 via the AV output unit 16.

Further, as shown in FIG. 1, in the recording and reproducing apparatus 2 on the LAN 5, a next generation (unknown) storage device (#5) 2b which will be described in detail later is mounted as a recording medium (storage device) in addition to the hard disk 2a. Further, one hard disk 3a as a recording medium is mounted in the recording and reproducing apparatus 3, two hard disks 4a, 4b are mounted in the recording and reproducing apparatus 4, and next generation storage devices (#4) na, (#8) nb are mounted in the recording and reproducing apparatus n (also refer to FIG. 3).

On the monitor 7, the current dubbing status, in other words, from what type of storage device to what type of storage device the dubbing is currently performed may be displayed by an object such as icon or text information under control of the MPU 17, as shown in FIG. 4. For example, it displays information such as “dubbing in progress: HDD→DVD”, “dubbing in progress: HDD→HDD”, “dubbing in progress: HDD→unknown storage device”, or the like.

The communication control unit 20 functions as a communication output unit outputting a request signal from the MPU 17 to LAN 5, as an input unit obtaining reply signals outputted from the other recording and reproducing apparatuses 2, 3, 4 . . . n to the LAN 5, and further as an output unit (dubbing output unit) of a digital contents signal. The request signal and the reply signal are exchanged with the MPU 17 via the communication control unit 20, and the digital contents signal from the disk drive 14 is outputted via the communication control unit 20. Incidentally, when this recording and reproducing apparatus 1 becomes “another recording and reproducing apparatus”, the communication control unit 20 becomes an input unit of a digital contents signal.

Examples of a network connectable to the communication control unit 20 includes, in addition to the LAN 5, the internet (for example, only an IP address matching from an upper digit to a certain digit (subnet) is applicable), and the like.

Here, a network dubbing function in the case that the next generation unknown storage devices (#5) 2b, (#4) na, (#8) nb on the LAN 5 are selected as a dubbing destination of contents in the recording and reproducing apparatus 1 will be described.

When reply results of type information of storage devices from the other recording and reproducing apparatuses 2, 3, 4, n on the LAN 5 are information indicating storage devices of unregistered type, the recording and reproducing apparatus 1 assigns in advance address information (for example, IP address) secured for unregistered types to the respective storage devices of unregistered type on the LAN 5. This is also one of functions of the MPU 17 (addressing unit). The type information is, for example, information such as 0x01: HDD, 0x02: DVD, 0x04HDD2, 0x08: storage device #4, 0x10:storage device #5, 0x20: storage device #6, 0x40: storage device #7 and 0x80: storage device #8. Here, the storage devices #4 to #8 are unknown storage devices to be adopted in the next generation. Here, corresponding to the number 1 to 80 in the type information, specifying address information to each storage device on the LAN 5 makes it possible that dubbing possibility does not depend on the type of a storage device.

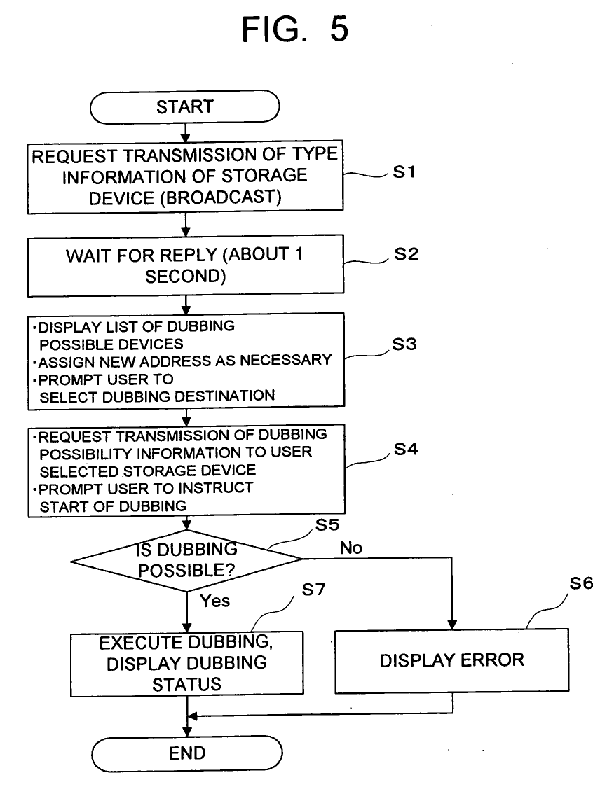

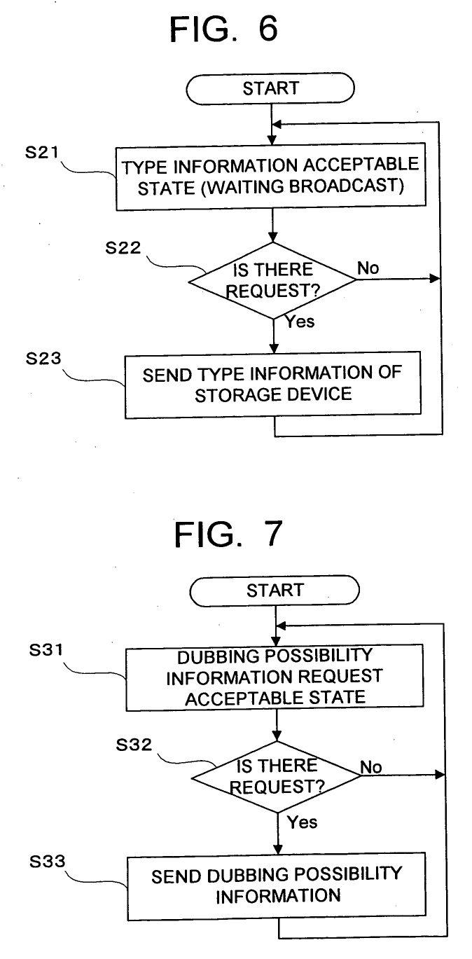

The case of carrying out network dubbing of contents between the above-described recording and reproducing apparatus 1 and the storage devices (recording media) of the other recording and reproducing apparatuses 2, 3, 4, . . . , n on the LAN 5 will be described using flowcharts shown in FIG. 5 to FIG. 8. Here, FIG. 5 is a flowchart showing the process of network dubbing in the recording and reproducing apparatus shown in FIG. 2, and FIG. 6 to FIG. 8 are flowcharts showing respective processes in a recording and reproducing apparatus as a dubbing destination among the recording and reproducing apparatuses in FIG. 1.

First, the recording and reproducing apparatus 1 mastering the network dubbing broadcasts on the LAN 5 to the other recording and reproducing apparatuses 2, 3, 4, . . . , n on the LAN 5 transmission request of type information of storage devices mounted in these recording and reproducing apparatuses (Step S1). While being in a type information request acceptable state (Step S21: FIG. 6), when the other recording and reproducing apparatuses 2, 3, 4, . . . , n receive the request (Yes in Step S22: FIG. 6), they reply type information of their respective retaining storage devices (Step S23: FIG. 6).

The recording and reproducing apparatus 1 waits for replies until type information is transmitted (Step S2), and thereafter, when it receives replied information, it displays a list of dubbing possible storage devices (dubbing destinations) on the monitor 7 (refer to FIG. 3), and prompts the user to select a dubbing destination (Step S3). Here, when the type information transmitted therefrom is the information indicating a storage device of unregistered type as described above, address information for an unregistered type is assigned to this storage device on the LAN 5 (the same step).

Next, when the user selects a desired storage device as a dubbing destination via the operation input unit 18, the MPU 17 functions as a dubbing possibility information requesting unit and requests transmission of dubbing possibility information to the recording and reproducing apparatus having this storage device via the network 5 (Step S4). At this time the request that specifies the recording and reproducing apparatus and the storage device uses address information, since the address information of the entire recording and reproducing apparatuses and the storage devices is available. While being in a dubbing possibility information request acceptable state (Step S31: FIG. 7), when the recording and reproducing apparatus to which the dubbing possibility information request is sent receives the request (Yes in Step S32: FIG. 7), it replies dubbing possibility information (for example, remaining capacity available for storage, the number of titles of contents which can be dubbed, and so on) of its storage device as the dubbing destination (Step S33: FIG. 7).

Thereafter, when the user requests to start the dubbing via the operation input unit 18 (Step S4), the MPU 17 judges whether the dubbing to the storage device as the dubbing destination is possible or not based on the dubbing possibility information replied therefrom (Step S5). If it is judged that the dubbing is impossible (No in Step S5), an error display is outputted to the monitor 7 (Step S6).

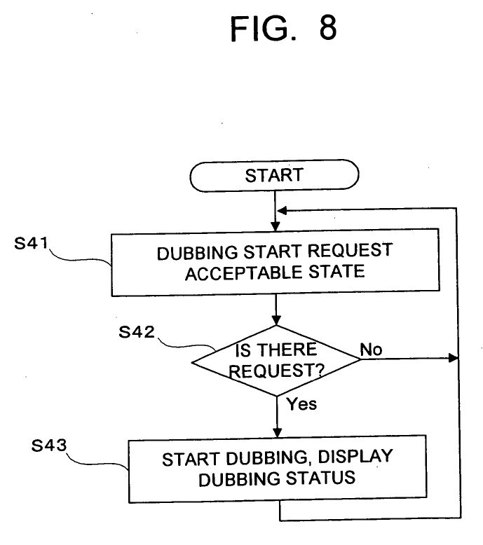

On the other hand, if it is judged that the dubbing is possible (Yes in Step S5), a dubbing start request is sent to the recording and reproducing apparatus which has the selected storage device. Thus, the dubbing is started via the communication control unit 20, and a dubbing status as shown in FIG. 4 is displayed on the monitor 7 (Step S7). The recording and reproducing apparatus as the dubbing destination after sending the dubbing possibility information is in a dubbing start request acceptable state (Step S41: FIG. 8), and when it receives the start request (Yes in Step S42: FIG. 8), it starts the operation as a dubbing destination (Step S43). At this time, the dubbing status as shown in FIG. 4 may also be displayed on the recording and reproducing apparatus as the dubbing destination.

Thus, according to the recording and reproducing apparatus 1 of this embodiment, also in the case that a recording and reproducing apparatus having a storage device of unregistered type is connected to the LAN 5, address information which is secured in advance can be assigned to this storage device of unregistered type on the LAN 5, so that even an unknown (next generation) storage device to be adopted in the future can be specified as a dubbing destination of contents.

In the foregoing, the present invention has been specifically described with the embodiment, but the present invention is not limited to the embodiment, and various modifications can be made without departing from the spirits of the invention. For example, in the above-described embodiment, the storage device is exemplified as one that is mounted in a recording and reproducing apparatus, but as a matter of course, the storage device as a dubbing destination may be a single hard disk device, a single optical disk device, or the like of so-called external type.

The present invention is understood not to be limited by any specific aspect described and illustrated herein but to embrace all variations which come within the scope of appended claims.

1. A recording and reproducing apparatus, comprising:
a type information requesting unit configured to request other recording and reproducing apparatuses connected via a network to transmit type information of storage devices mounted in the other recording and reproducing apparatuses via the network;
a type information receiving unit configured to receive the type information of the storage devices which is transmitted in response to the request; and
an addressing unit configured to assign, if the received type information of the storage devices is information indicating a storage device of unregistered type, address information secured for an unregistered type in advance to the storage device.

2. A recording and reproducing apparatus as set forth in claim 1, further comprising:
a dubbing possibility information requesting unit configured to request one of all storage devices on the network including the storage device to which the address information is newly assigned to transmit information indicating possibility of dubbing.

3. A recording and reproducing apparatus as set forth in claim 1, further comprising:
a selection requesting unit configured to prompt discretional selection of a storage device by notifying the type information of the storage devices transmitted in response to the request; and
a dubbing output unit configured to output contents via the network to the selected storage device.

4. A dubbing method, comprising:
requesting other recording and reproducing apparatuses connected via a network to transmit type information of storage devices mounted in the other recording and reproducing apparatuses via the network;
receiving the type information of the storage devices which is transmitted in response to the request; and
assigning, if the received type information of the storage devices is information indicating a storage device of unregistered type, address information secured for an unregistered type in advance to the storage device.
